(19) United States
(12) Patent Application Publication
(10) Pub. No.: US 2015/0103400 A1
(43) Pub. Date: Apr. 16, 2015

(54) Solar Protection Glove Providing Touch

(71) Applicant: Ladan Porooshani, San Diego, CA (US)

(72) Inventor: Ladan Porooshani, San Diego, CA (US)

(73) Assignee: ABLE BROADCASTING, INC., San Diego, CA (US)

(21) Appl. No.: 14/052,612

(22) Filed: Oct. 11, 2013

(51) Int. Cl. A41D 19/015; G02B 5/20; G02B 7/00; A41D 19/00

(52) U.S. Cl. CPC A41D 19/015; A41D 19/0017; A41D 19/0048; G02B 5/208; G02B 7/002
USPC 359/361; 2/169; 112/475.09

(57) ABSTRACT

The invention is a general purpose glove that provide solar protection for the back of the user's hand while leaving the palm and finger pads exposed. By leaving the palm-side of the hand exposed the wearer is provided with an unimpeded sense of touch and greater control over the tools being used and a dryer and cooler hand. The invention can be made of UPF fabric, or some other material providing less UV protection.

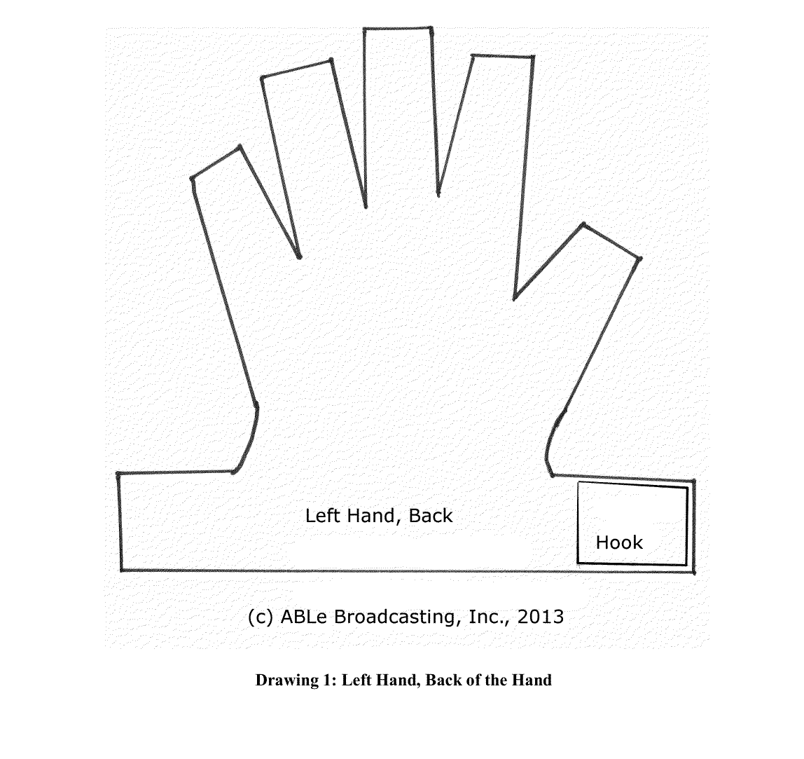

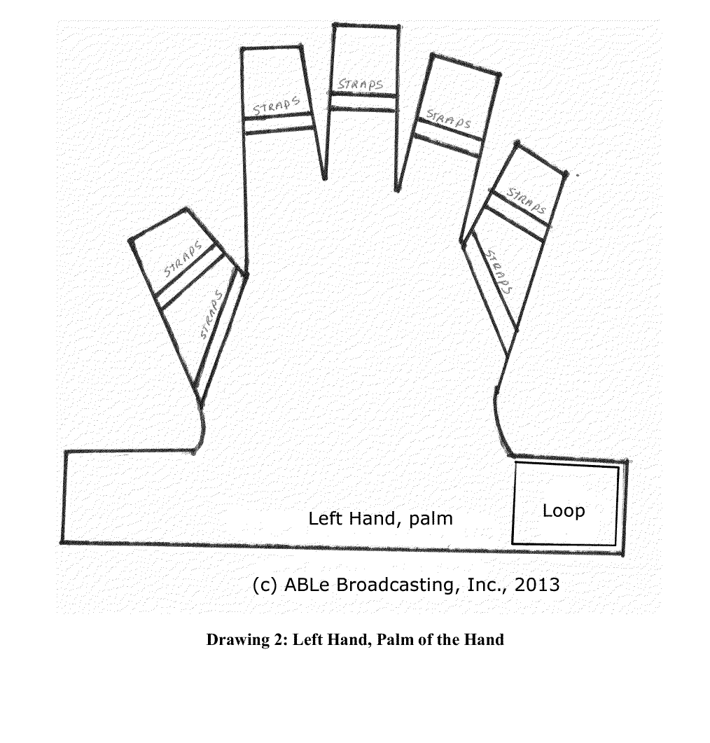

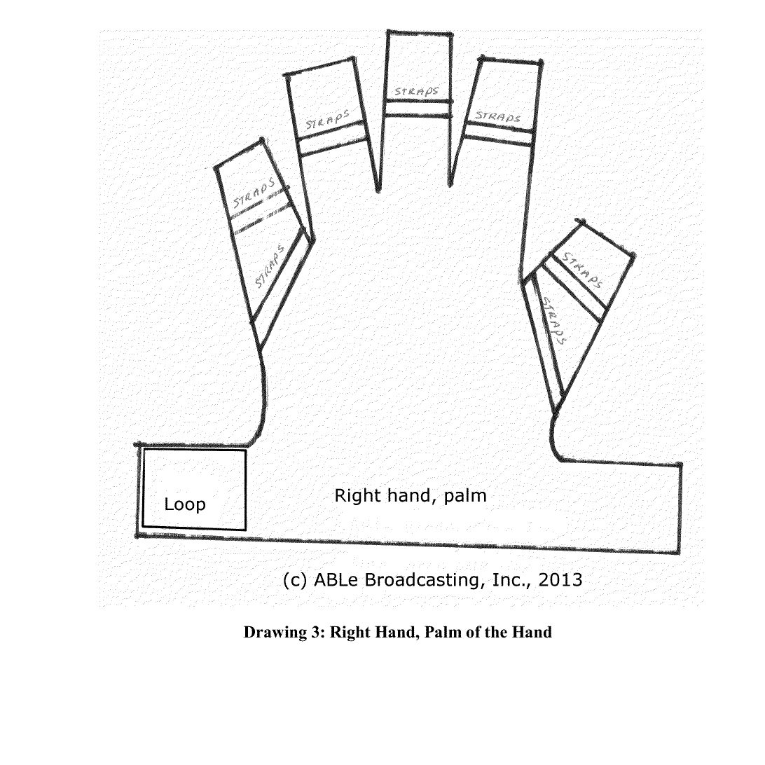

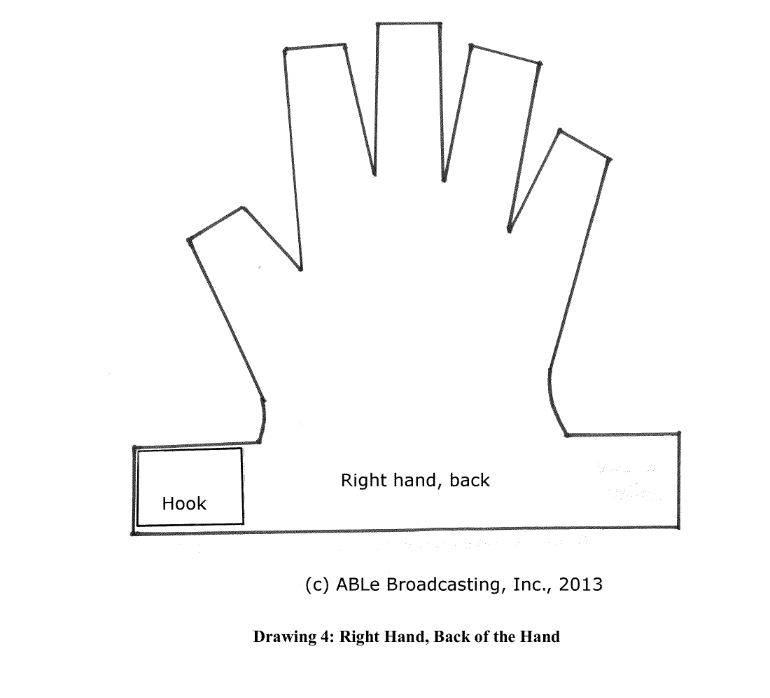

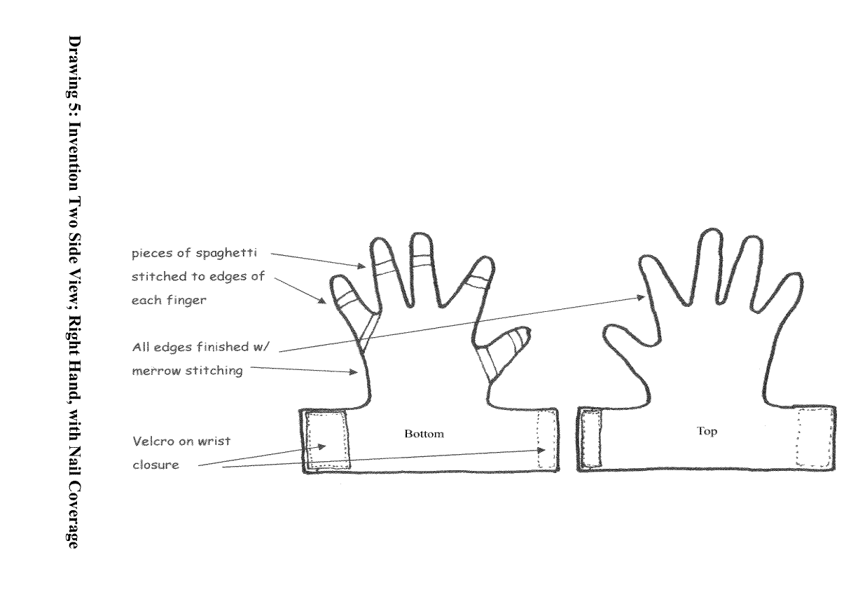

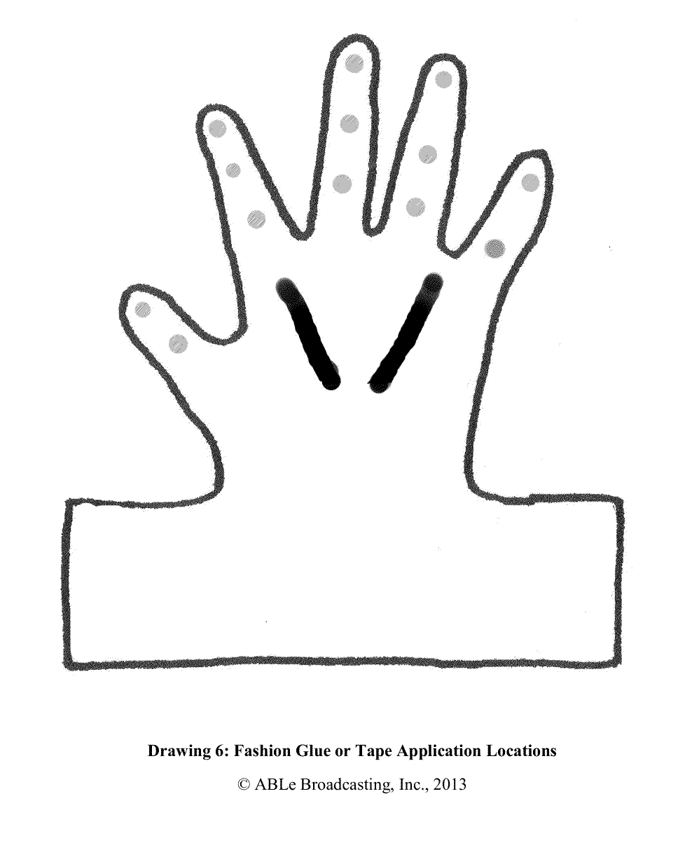

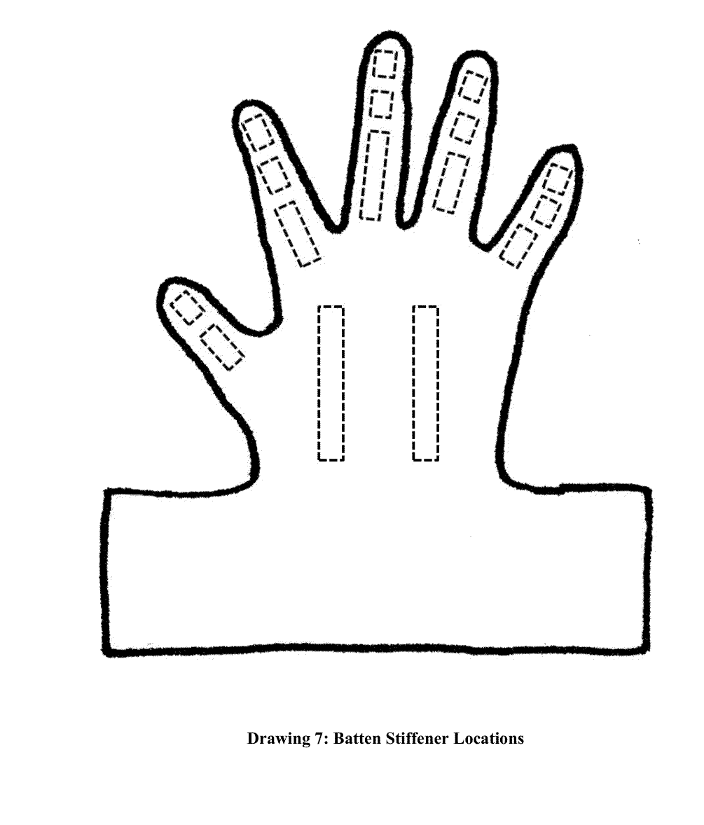

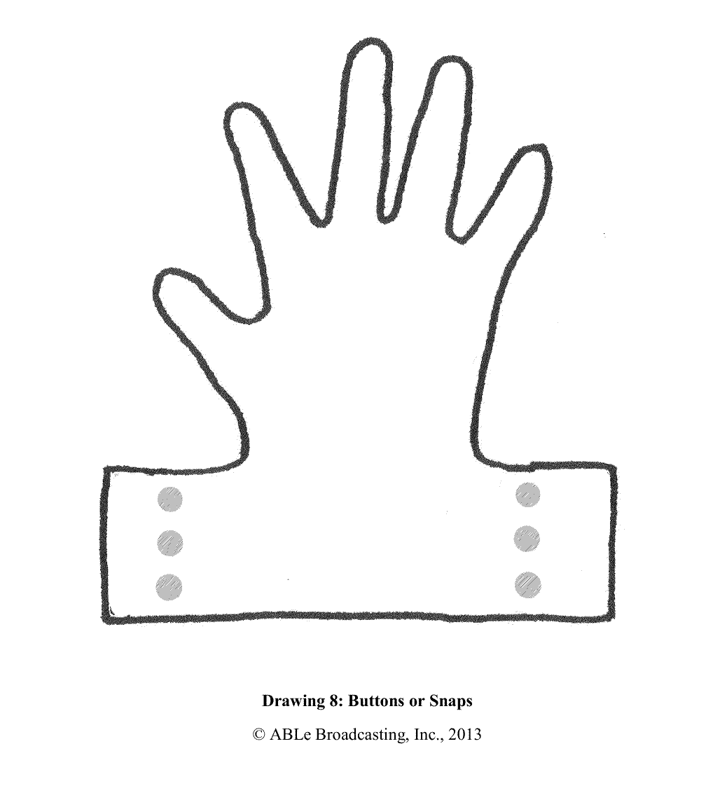

### 2 CROSS REFERENCE TO RELATED APPLICATIONS

None

### 3 STATEMENT OF FEDERALLY SPONSORED R&D

No federal R&D funds were used in the invention.

### 4 JOINT RESEARCH AGREEMENT PARTIES

Not applicable.

### 5 REFERENCE TO A SEQUENCE LISTING

N/A

### 6 BACKGROUND OF THE INVENTION

Over the past decade, and perhaps longer, people have become more aware of the damaging effect of solar exposure on human skin. The damaging effects are now believed to be compounding, so that even short term exposure to unprotected human skin contributes to greater long term skin damage. Such damage includes “sun spots”, dry and/or wrinkling, premature aging, and even development of fatal melanoma cancers.

A strong market exists for many types of solar protection products including hats, sun screens (in various forms such as creams and sprays), and various clothing items providing various degrees of solar radiation abatement.

However, notably absent has been the development of skin care protection for hands, short of full hand covering (gloves) with various specialized applications (such as golf gloves, driving gloves, batting gloves, baseball mitts, football receiver gloves, cotton and leather work gloves and many others). And in most cases, the purpose of these gloves is to provide protection to the skin on the palm of the hand from damage related to that particular activity, or to enhance the natural grip of the hand on the particular tool used in that activity. For example, the purpose of a golf glove it primarily to prevent blisters from forming from rubbing on the club's grip handle as well as to provide enhanced grip on the club to avoid the clue spinning in the hand upon contact causing a misdirected shot.

However all of these types of gloves do not to provide full protection from solar exposure to the hand and a full sense of touch to the wearer engaged in the activity. This functional gap is addressed by the subject of this application, “Solar Protection Glove Providing Touch”. Through the unique recognition of the existing product gap, and creating novel methods of attaching the covering to the hand while leaving the palm exposed to provide the advantage of a sense of touch, the inventor has satisfied this need.

### 7 BRIEF SUMMARY OF THE INVENTION

The invention is the top half of a glove made of solar-protective material of various ultraviolet protection strengths. It can be made of one or more layers to also provide some thermal or wind protection. This glove has a cuff, several closure methods and attaches to the fingers and thumb by straps as one of several methods. All of these methods minimize or eliminate obstruction of the wearer's palm and finger pads. By leaving the wearer's palm and finger pads exposed, the wearer retains a full sense of touch identical to non-protected (no glove) hands performing that activity.

### 8 BRIEF DESCRIPTION OF THE DRAWINGS

Drawing 1: Left Hand, Back of the Hand (below) shows the top of the invention as when worn on the back of the hand, and viewed with the back of the wearer's hand facing the wearer. In this view the straps are not visible. The cuff is shown “open” and when worn wraps around the wrist. This Drawing 1 is a fabric cutting pattern.

Drawing 2: Left Hand, Palm of the Hand (below) is a view of the left hand palm-side. The diagram is shown as when the glove is worm and looking at the wearer's palm.) Note that the glove does not actually cover the wearer's palm. When worn and viewed from the palm-side, the straps are visible, and the cuff is visible as it wraps around the wearer's wrist. The positions of the finger straps are shown when attached as described in Section 9.4.

Drawing 3: Right Hand, Palm of the Hand (below) is a view of the right hand palm-side. The diagram is shown as when the glove is worm and looking at the wearer's palm. Note that the glove does not actually cover the wearer's palm. When worn and viewed from the palm-side, the straps are visible, and the cuff is visible. The positions of the finger straps are marked when attached as described in Section 9.4.

Drawing 4: Right Hand, Back of the Hand (below) shows the top of the invention as when worn on the back of the hand, and viewed with the back of the wearer's hand facing the wearer. In this view the straps are not visible. The cuff is shown “open” and when worn is visible as it wraps around the wrist. This Drawing 4 is a fabric cutting pattern.

Drawing 5: Invention Two Side View; Right Hand, with Nail Coverage (below) shows a drawing of the bottom-side (also called “palm side”) and top-side (also called “back side”) of a right-hand glove. Construction is identical for a left-hand glove, except that the straps are attached to the obverse side for the left-hand glove. Drawing 5 shows the invention style providing fingertip protection (finger nail coverage). The left-side sketch in this Drawing 5 shows the finger straps (as described in Section 9) and marked as “spaghetti” in the drawing. Since the straps are visible on this hand side, and its thumb covering points to the right, that is the right-hand glove. It appears as if the wearer views the palm of their right hand and can see the straps though most of the fabric would be obscured by their hand. The straps are not visible on the top of the glove (right side sketch of Drawing 5). It appears as if the wearer is looking at the back of their right hand, and can see most of the fabric providing their right hand with sun protection.

Drawing 6: Fashion Glue or Tape Application Locations (below) depicts the top of the invention where a glue material is used on the fabric and in contact with the wearer's hand to attach the invention to the hand. Spots of glue or tape are used on the finger areas to provide for flexibility and avoid interfering with the wearer's finger joints. Lines of glue have been tested in prototypes of the inventions to demonstrate sufficient adhesion to the back of the hand.

Drawing 7: Batten Stiffener Locations (below) shows the invention using battens to stiffen the solar protective material. The battens cause the top of the glove to be stiffer and straight as it lies on the wearer's hand. Note that the battens in the fingers are multi-pieced and avoid the locations of the wearer's finger joints. The battens are placed between the 2-ply material, typically with non-drying glue on both sides of the battens, but in a limited quantity so as to avoid soaking and staining the fabric.

Drawing 8: Buttons or Snaps (below) shows another possible method of securing the invention to the wrist. In this case, the invention is manufactured with one or multiple buttons or snap-sets to be attached across the two cuff ends. This is a drawing of the top of the glove, and the finger straps are not visible on this side.

### 9 DETAILED DESCRIPTION OF THE INVENTION

### 9.1 Key Distinguishing Features

The invention is the “top half” of a glove made of Ultraviolet Protective Fabric (“UPF”) of a desired strength (for example, “UPF 50”). The UPF rating is conceptually similar to the SPF numbering familiar to many people from sunscreen products. The materials are readily available on the market, and are light-weight and flexible. The invention is made of two layers (ply) of the fabric, so the SPF strength of the material is increased by the 2-ply construction. The UPF fabric can also be moisture wicking. When worn with the 2-ply construction for solar protection, the wearer will experience diminished hand sweating since the invention keeps the hand cooler due to the solar protection and the open construction allows for air-flow and natural evaporation. The invention also works to protect the back of the wearer's hand from the cold. Additional layers can be used to also provide some thermal or other environmental protection. Or, a single-ply (layer) of fabric can be used, but its manufacture will require special edge stitching, such as merrow stitching.

This invention has a cuff with closures. Closures come in many different forms such as hook/loop material, buttons, snaps, or others. The invention attaches to the fingers and thumb by one of several methods. All of these methods minimize or eliminate obstruction of the wearer's palm and finger pads. By leaving the wearer's palm and finger pads exposed, the wearer retains a full sense of touch to provide the wearer touch sensation identical to non-protected (no glove) hands performing that activity.

Attachment to the fingers can be made with a set of critically located straps of fabric, elastic, or other materials (see Drawing 2 and Drawing 3). In the inventor's design work, half-inch wide elastic straps have been selected as the best tradeoff for ease and effectiveness of use and lowest cost of manufacturing.

### 9.2 Other Attachment Methods Developed

Alternately the invention can be secured to the hand using a commercially available re-usable glue or “fashion tape” to “stick” the glove to the back of the hand and the fingers (see Drawing 6). Glue loses stickiness due to wear and the effect of washing but further research (studies with other types of glues) will likely result in solutions to these issues. Fashion tape is commonly used to secure clothing in place, so it is an economical alternative.

Another implementation of the invention used a set of battens (in the case of the prototype, plastic strips that provided stiffening to the material so that it conformed to the back of the hand). Though this method proved to be not as comfortable on the hand (see Drawing 7). (Battens can't be used as the means of attaching the fabric to the hand. Nor do they eliminate the need for straps. Battens are only used to stiffen the fabric when worn on the hand. Lacking straps the invention will fall off the wearer's fingers.)

Selection of the preferred hand attachment method becomes a manufacturing cost tradeoff against effectiveness of touch sensitivity. The inventor prefers hook/loop material on the cuff, and finger straps (made of fabric or elastic).

### 9.3 Advantage of Reduced Inventory Costs

Due to the non-encasing nature of the invention's design, a minimal number of sizes need to be manufactured. We have prototyped unisex sizes of XS, S, M, L, XL, XXL, and believe these will be sufficient for all markets. This is not possible in traditional gloves where finger length and diameter make fitting critical to many hand sizes. For example, golf gloves are sold in as many as twelve sizes (2x Large, 3x Large, Cadet Large, Cadet Medium, Cadet Medium/Large, Cadet Small, Cadet Extra Large, Extra Large, Large, Medium, Medium Large, Small) across ages and genders.

### 9.4 Method of Manufacture

The inventor has created a method to manufacture the invention that is unique. The construction of regular gloves is based on a commonly used pattern and the manufacturers are very familiar with this pattern and are able to cut and sew it adroitly. The pattern and sewing of this glove is quite unique and does not conform to traditional glove manufacturing. The inventor has worked through numerous prototypes resulting in the invention being practical to manufacture and market at a competitive price. The inventor has created the following manufacturing instructions for producing the invention, in this case, based on the use of fabric or elastic straps and a hook and loop or snaps or buttons on the cuff:

TABLE 1
Manufacturing Instructions Depicting Unique “Inside-Out” Assembly
Sewing Instructions (Fabric Straps)

Place 2-ply fabric on a table
Place glove pattern on 2-ply fabric and cut
Turn the glove fabric inside out for sewing
Cut seven (7) bands for each hand. 1″ by 1¼″ each
Fold and sew each fabric band individually with clean seams. If
using elastic bands, just cut to size.
Place each band between the 2-ply fabrics so it ends up on the
middle of each finger exactly as shown in Drawing 2 or Drawing 3.
(The band must remain in the middle of each finger when worn.)
Start from one end of the wrist area and sew around each finger.
Leave the other side of wrist open so that the fabric can be turned
right side out first.
Turn the fabric right side out by pushing each finger out
Finish sewing the other end of the wrist area
Sew the hook/loop, buttons, or snaps to the wrist band area
Add identifying or statutorily required fabric tags and monogram
(if any)

If one-ply fabric is used then a different method of stitching can be used on the edges of the fabric to achieve a clean look, such as “merrow stitching”. The inventor prefers the two-ply fabric construction method described in Table 1 as the seam looks cleaner and is almost invisible.

### 9.5 Example Fields of Use

The invention is suitable for many fields of use. It is well suited for use in sports that require a sense of touch and which are played outdoors in sunlight. Tennis (or lawn tennis) is an excellent example of a sports application.

The invention can be used for driving, especially in the daylight where the hours of sun exposure to the hands on the steering wheel require sun protection. Similarly the invention can also be used to provide solar exposure protection while walking.

The glove can also be used in professional applications where solar protection is desirable, but use of a writing instrument (such as a pencil or pen) is needed. Since it is very difficult to write with a gloved hand, the invention provides the sense of touch needed for writing. The invention could be used by field inspectors and technicians that are working out of doors at plants and are recording observations of sensors on paper or on touch-sensitive tablets. Another similar use would be the members of a survey team that need to use fine control on their instruments and record observations on reports.

1. The invention provides solar protection to hands. The invention is made of UPF (Ultraviolet Protecting Fabric) material that covers the back of the wearer's hands and is designed to conform closely to the hands. Since the invention is constructed of 2-plys of UPF material the level of UV protection can be very high.
Sub-claim 1.1: One modification of the design of the invention can leave the finger nails exposed. Leaving the fingernails exposed provides an advantage for fine motor control applications (such as writing, or critical machine adjustments) and also helps avoid having the invention interfere with moving parts. Further, this claim provides for enhanced wearer satisfaction if nail manicures have been performed and display of that manicured finish is appropriate.
Sub-claim 1.2: Another modification of the design of the invention can cover the finger nails. This claim provides the advantage of extending the solar protection further up the back of the fingers, if the advantages listed in Sub-claim 1.1 are not essential.
Sub-claim 1.3: The invention provides for cooler and dryer hands. The combination of the UV protection and the open design of the invention keep the wearer's hand cooler and dryer than an unprotected hand. The invention provides for excellent air flow due to its open design. That air flow combined with the solar protection allows for natural evaporation and cooling. It also provides protection to the back of the wearer's hand from cold.

2. The invention provides sense of touch to user's palm. This is a key feature of the invention that any and all other gloves fail to provide. It has the advantage over topical sunscreens of not spreading beyond the area of application to the palm, fingertips, or elsewhere. Sense of touch is critical in many fields of use, examples for which include holding sports equipment (for example, a tennis racket), writing instruments (pens, pencils), or using touch-sensitive user interfaces (such as a tablet computer).
Sub-claim 2.1: Exposes finger tips and finger pads for fine touch sense (pressure, temperature, texture). With exposed finger pads, all of the benefits in claim 2 are provided. The finger pads provide important sensations to humans, especially texture, pressure, and temperature. These areas being exposed are critical for fine motor control.
Sub-claim 2.2: The invention exposes the palm for touch sense. The exposed palm allows for more controlled use of hand and arm forces transmitted through the hand. In racket sports, for example, the racket is pressed to the palm by the fingers and it is the surface of the palm that provides the grip and point of leverage for the application of power.

3. The invention provides for easy and secure fitting and simple cost effective manufacturing though a number of methods. The invention embodies a unique design for ease of manufacturing an attractive and reasonably priced consumer and professional use product. The method of manufacture, created by the inventor and described in Section 9.4, is unique to this invention.
Sub-claim 3.1: Invention can use hook and loop type fastener on the cuff. Commonly called “Velcro”¹ this commercially available material provides an excellent closure. It provides a secure wrist binding, and allows for flexible and variable wrist sizing. The invention can use any fasteners, such as buttons or snaps.
Sub-claim 3.2: Invention can use an elastic cuff. Another method of attaching the invention to the wearer's wrist is a broad band of elastic material. This method also provides for a secure fit, but lacks the ability to adjust the tightness of fit.
Sub-claim 3.3: Invention can be secured to fingers using straps made of fabric, elastic, or other materials. The straps as shown in Drawing 2 and Drawing 3 are located to fit on the user's finger joint locations, leaving the finger pads exposed to allow for the unobstructed sense of touch. They also provide secure attachment of the invention to the wearer's hands. Different materials can be used for these straps, provided that they allow for a sufficiently secure fit and allow for use by various finger diameters for sizing purposes for different wearers.
Sub-claim 3.4: Invention can be secured to fingers using re-usable glue drops or fabric tape applied to the invention and stuck to the fingers and the back of the hand at a set of points. By securing the invention to the back of the hand with a set of glue or tape spots (see Drawing 6) the fingers are entirely free of any materials and the entire palm and palm-side fingers are exposed.
Sub-claim 3.5: Invention can include the use of battens to provide rigidity to the glove's fingers and back-hand area. Battens are commonly used in clothing application, such as for collar stays (stiffeners). In the invention, light weight battens, typically made of plastic but any semi-rigid lightweight material could be used, to provide greater “body” to the solar protection material and help to keep it without wrinkles or puckers. The invention provides its key benefits with or without the battens.
Sub-claim 3.6: The invention is cut from fabric using only a one-piece-pattern and one- or two-ply fabric. A conventional glove pattern requires multiple pieces being cut from the fabric for the body, the thumb, and the three gussets (or fourchettes). The invention does not require the thumb or gusset cuts. The one-cut-pattern (see Drawing 1) design of the invention provides for very simple manufacturing when including the use of the inventor's manufacturing steps discovered and outlined in Section 9.4.
Sub-claim 3.7: The invention is assembled “inside-out” with continuous edge sewing around the entire pattern, and then inverting the assembly. This is a summary description of the unique method of manufacture detailed in Section 9.4. This unique method of manufacture provides for a robust and attractive end product that can be manufactured at a reasonable cost.
